(19) United States
(12) Patent Application Publication
(10) Pub. No.: US 2026/0236303 A1
(43) Pub. Date: Aug. 13, 2026

(54) MEMORY ALLOCATION TECHNIQUE FOR LOAD BALANCED SYSTEMS

(71) Applicant: Visa International Service Association, San Francisco, CA (US)

(72) Inventors: Shivam Mohan, San Francisco, CA (US); Sudharshan Krishnakumar Gaddam, San Francisco, CA (US); Prakhar Gangwar, San Francisco, CA (US); Prithwish Banerjee, San Francisco, CA (US); Pradeep Choube, San Francisco, CA (US); Ravi Shanker Kumar Sinha, San Francisco, CA (US); Neeraj Surana, San Francisco, CA (US); Kandikatla Varshini, San Francisco, CA (US); Alok Roy, Gunjur (IN)

(73) Assignee: Visa International Service Association, San Francisco, CA (US)

(21) Appl. No.: 19/159,223

(22) PCT Filed: Feb. 27, 2023
(86) PCT No.: PCT/US2023/063372

§ 371 Date: Aug. 22, 2025

(51) Int. Cl. G06F 9/50; G06N 20/00

(52) U.S. Cl. CPC G06F 9/5016; G06F 9/5038; G06N 20/00

(57) ABSTRACT

A memory management for a computer system that executes multiple concurrent jobs can use machine learning techniques, such as reinforcement learning, to learn and exploit patterns of memory requests. Patterns or sequences of allocations that result in increased memory utilization can be learned, and subsequent decisions to grant allocation requests or wait for additional requests can be informed by the learned patterns.

### BACKGROUND

This disclosure relates generally to memory management in a computer system and in particular to memory allocation techniques to improve utilization of memory in load balanced systems.

Memory in a computer system refers generally to circuits and devices that can store information, typically in the form of bits. Most computer systems include a fixed amount of addressable memory (sometimes referred to as random access memory) that can be accessed by processes executing in the system, and an address space is defined such that each physical location in the memory has a unique address. Processes executing in the system access memory, e.g., in read or write operations, by reference to the address of the location where the data is stored.

Where a computer system executes multiple concurrent processes, it is desirable to avoid memory address conflicts, which can arise when two processes attempt to use the same memory location to store different data. Accordingly, operating systems typically include a memory management unit that is tasked with allocating nonoverlapping subsets of the memory address space to different processes. Processes can request blocks of memory of a desired size, and the memory management unit assigns a block of addresses of the appropriate size to the process. The memory management unit keeps track of which portions of the address space are free and which are allocated to which processes. As processes complete, their allocated memory addresses are freed and can be reallocated to other processes. For convenience, the machine-level program code implementing a process may use “base-plus-offset” addressing, on the assumption that the process will be allocated a contiguous portion of the memory address space.

Commonly-used paradigms for memory allocation include segmentation and paging. In segmentation, the memory management unit allocates a single contiguous block (or “segment”) of memory address space in response to each request and provides a base address (typically the first address in the allocated block) for use by the requesting process. Segmentation is convenient for base-plus-offset addressing but can result in situations (referred to as “external fragmentation”) where a memory request cannot be granted because, while there is a sufficient amount of free memory, that memory is not in a single contiguous block. External fragmentation can result in delays in process execution and inefficient use of the computer system.

Paging attempts to avoid external fragmentation. In paging, the memory address space is divided into fixed-sized portions (e.g., 4 KB), referred to as pages. When an allocation request is received, the memory management unit allocates a number of pages that is at least as large as the requested block. Each page consists of contiguous addresses, but the pages allocated need not be contiguous with each other. Instead, a page table is used to map the address offsets for a particular process to addresses in the allocated pages. Paging can avoid external fragmentation. However, “internal” fragmentation can occur. For instance, if a process requests a 5 KB block of memory and the page size is 4 KB, then 8 KB must be allocated to the process. In addition, the page table introduces overhead. The page table itself occupies a portion of the memory, and servicing of memory access requests entails accessing the page table to translate requested addresses (typically specified as base-plus-offset) to addresses in the memory space.

### SUMMARY

Certain embodiments disclosed herein relate to memory management for a computer system that executes multiple concurrent processes. In some embodiments, a memory management unit can use machine learning techniques, such as reinforcement learning, to learn and exploit patterns of memory requests. Patterns or sequences of allocations that result in increased memory utilization can be learned, and subsequent decisions to grant allocation requests or wait for additional requests can be informed by the learned patterns. This process can increase average memory utilization and thereby improve system efficiency.

Certain embodiments relate to methods for managing memory in a computer system. A memory management unit of a computer system can receive a request from an executing process in the computer system for a memory allocation from a pool of memory, the request specifying a size of the memory allocation. The memory management unit can determine, based on a trained machine learning model that predicts an effect of a memory allocation decision on memory utilization, whether to grant the request or to wait. In response to determining to grant the request, the memory management unit can allocate a segment of memory from the pool of memory to the executing process. In response to determining to wait, the memory management unit can add the request to a pending request list.

In these and other embodiments, the memory management unit can periodically process the pending request list. Periodically processing the pending request list can include, for each request in the pending request list: determining, by the memory management unit, based on the trained machine learning model, whether to grant the request or to wait; in response to determining to grant the request, allocating, by the memory management unit, a segment of memory from the pool of memory to the executing process; and in response to determining to wait, incrementing, by the memory management unit, an age counter for the request. In some embodiments, for each request in the pending request list, the memory management unit can determine whether the age counter for the request exceeds a threshold value. In response to determining that the age counter for the request exceeds the threshold value, the memory management unit can allocate a segment of memory from the pool of memory to the executing process associated with the request.

In these and other embodiments, the machine learning model can be trained using reinforcement learning wherein decisions that increase memory utilization are associated with a positive reward and decisions that decrease memory utilization are associated with a negative reward. In some embodiments, training the machine learning model includes: subsequently to determining whether to grant the request or to wait, evaluating a memory utilization outcome; and using the memory utilization outcome to update the machine learning model.

In these and other embodiments, the machine learning model can be based on optimizing an order of granting a plurality of predicted requests to reduce memory fragmentation.

In these and other embodiments, the machine learning model can be trained to predict whether waiting to grant the request until after an expected subsequent request is granted will result in higher memory utilization than immediately granting the request.

Certain embodiments relate to computer systems including a processor to execute instructions and a memory coupled to the processor. The processor can be configured to execute multiple jobs concurrently and further configured to execute a memory management process. The memory can be configured to store data for jobs being executed by the processor. The processor can be further configured such that executing the memory management process includes: receiving a request to allocate memory to a specific job being executed by the processor, the request specifying an amount of memory to be allocated; determining, based on a trained machine learning model that predicts an effect of a memory allocation decision on memory utilization, whether to grant the request or to wait; in response to determining to grant the request, allocating a contiguous block of memory at least equal to the requested amount of memory to the specific job; and in response to determining to wait, adding the request to a pending request list.

In these and other embodiments, the processor can be further configured such that the memory management process further includes periodically processing the pending request list and such that periodically processing the pending request list includes, for each request in the pending request list: determining, based on the trained machine learning model, whether to grant the request or to wait; in response to determining to grant the request, allocating a segment of the memory to the specific job associated with the request; and in response to determining to wait, incrementing an age counter for the request. In some embodiments, periodically processing the pending request list can also include, for each request in the pending request list: determining whether the age counter for the request exceeds a threshold value; and in response to determining that the age counter for the request exceeds the threshold value, allocating a segment of the memory to the specific job associated with the request.

In these and other embodiments, the computer system can further include a communication interface configured to communicate with one or more other computer systems, and the processor can be further configured to receive requests to execute jobs via the communication interface.

In these and other embodiments, the processor can be further configured to execute a machine learning process to train the machine learning model. In some embodiments, the machine learning process can use reinforcement learning in which decisions that increase memory utilization are associated with a positive reward and decisions that decrease memory utilization are associated with a negative reward. In some embodiments, the computer system can include a training data store configured to store training data for the machine learning process, the training data including sequences of received requests, sequences of allocations made in response to received requests, and memory utilization data, and the processor can be further configured to add training data to the training data store while executing the memory management process.

Some embodiments relate to a computer-readable storage medium having stored therein program code instructions that, when executed by a processor of a computer system, cause the computer system to implement a memory management process comprising: receiving a request from an executing job in the computer system for a memory allocation from a pool of memory, the request specifying a size of the memory allocation; adding the request to a pending request list; and periodically processing the pending request list, wherein processing the pending request list includes, for each pending request: determining, based on a trained machine learning model that predicts an effect of a memory allocation decision on memory utilization, whether to grant the pending request or to wait; in response to determining to grant the pending request, allocating a segment of memory from the pool of memory to the executing job; and in response to determining to wait, incrementing an age counter associated with the pending request.

In these and other embodiments, processing the pending request list can also include, for each pending request: determining whether the age counter for the request exceeds a threshold value; and in response to determining that the age counter for the request exceeds the threshold value, allocating a segment of memory from the pool of memory to the executing job associated with the request.

In these and other embodiments, additional program code instructions can be stored that, when executed by a processor of a computer system, cause the computer system to implement a machine learning process to train the machine learning model. In some embodiments, the machine learning process can implement reinforcement learning wherein decisions that increase memory utilization are associated with a positive reward and decisions that decrease memory utilization are associated with a negative reward. In some embodiments, the machine learning model can be based on optimizing an order of granting a plurality of predicted requests to reduce memory fragmentation. In some embodiments, the machine learning model can be trained to predict whether waiting to grant the request until after an expected subsequent request is granted will result in higher memory utilization than immediately granting the request.

The following detailed description, together with the accompanying drawings, will provide a better understanding of the nature and advantages of the claimed invention.

### BRIEF DESCRIPTION OF THE DRAWINGS

FIG. 1 shows a simplified block diagram of a computer system 100 configured to execute various processes according to some embodiments.

FIG. 2 shows a simplified block diagram of a memory management unit 200 according to some embodiments.

FIG. 3 is a flow diagram of a process 300 for handling a memory allocation request according to some embodiments.

FIGS. 4A and 4B show simplified examples of memory space allocation sequences according to some embodiments.

FIG. 5 illustrates a portion of a state machine 500 according to some embodiments.

FIG. 6 shows a flow diagram of a process 600 for managing a pending request list according to some embodiments.

### TERMS

The following terms may be used herein.

A “computer system” refers generally to a device or apparatus that is capable of executing program code (also referred to as “instructions”). A computer system can include a processor and a memory, as well as other components such as user interfaces that enable human interaction with the computer system and/or communication interfaces that enable computer systems to exchange information-bearing signals with other computer systems.

A “processor” may refer to any suitable data computation device or devices. A processor may comprise one or more microprocessors working together to achieve a desired function. The processor may include a CPU that comprises at least one high-speed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and/or Xscale; and/or the like processor(s).

“Memory” may refer to circuits or devices that can store data being operated on by a processor in a computer system. Examples include DRAM, SRAM, flash memory, and so on. Unless otherwise specified, memory is assumed herein to be “addressable,” meaning that the memory includes multiple distinct storage locations (e.g., bits, bytes, or words), each of which is associated with a unique identifier, referred to as an “address,” and a particular storage location can be accessed (to read and/or write data) by reference to the address.

A “job” (or “process”) executing in a computer system may refer to any instance of executing a sequence of instructions, without limitation to the nature of the instructions or scale of the program code. An executing job may require or benefit from exclusive use of various resources of the computer system, such as a portion of the memory.

A “server computer” may refer to a computer or cluster of computers. A server computer may be a powerful computing system, such as a large mainframe. Server computers can also include minicomputer clusters or a group of servers functioning as a unit. In one example, a server computer can include a database server coupled to a web server. In another example, a server computer can include a collection of processors, a communication interface that receives requests to execute jobs using the processors, and a control system that assigns jobs to specific processors. A server computer may comprise one or more computational apparatuses and may use any of a variety of computing structures, arrangements, and compilations for servicing requests from one or more client computers.

A “client computer” may refer to a computer or cluster of computers that receives some service from a server computer (or another computing system). The client computer may access this service via a communication network such as the Internet or any other appropriate communication network. A client computer may make requests to server computers including requests for data or requests to execute a job (or program). As an example, a client computer can send a request to a server to process a batch of transaction data. A client computer may comprise one or more computational apparatuses and may use a variety of computing structures, arrangements, and compilations for performing its functions, including requesting and receiving data or services from server computers.

A “machine learning model” may refer to a file, program, software executable, instruction set, etc., that has been “trained” to recognize patterns or make predictions. For example, a machine learning model can take transaction data records as an input, and classify each transaction data record as corresponding to a legitimate transaction or a fraudulent transaction. As another example, a machine learning model can take weather data as an input and predict if it will rain later in the week. A machine learning model can be trained using “training data” (e.g., to identify patterns in the training data) and then apply this training when it is used for its intended purpose. A machine learning model may be defined by “model parameters,” which can comprise numerical values that define how the machine learning model performs its function. Training a machine learning model can comprise an iterative process used to determine a set of model parameters that achieve the best performance for the model.

“Reinforcement learning” may refer to a type of machine learning in which a file, program, software executable, instruction set, etc., is trained to select an action to take given a current state, such as a direction in which to move an object such as a car or robot from a given location to another location, based on a particular goal to be achieved, such as reaching a specific destination while avoiding hazards. The state can be defined to include current information (e.g., current location and surroundings, such as potential hazards) as well as contextual information (e.g., previous locations and/or actions). The action can be selected from a finite set of actions (e.g., move forward, back, left or right, or wait). For training purposes, actions can be associated with rewards, which can be positive or negative. For instance, an action that advances the object safely toward the goal may have positive reward while an action that moves the object away from the goal or into a hazard may have negative reward. Selection of an action can be based on comparing predicted cumulative rewards associated with taking different actions when in a particular state. The predicted cumulative rewards for various combinations of state and action can be model parameters that are determined by training.

### DETAILED DESCRIPTION

The following description of exemplary embodiments is presented for the purpose of illustration and description. It is not intended to be exhaustive or to limit the claimed embodiments to the precise form described, and persons skilled in the art will appreciate that many modifications and variations are possible. The embodiments have been chosen and described in order to best explain their principles and practical applications to thereby enable others skilled in the art to best make and use various embodiments and with various modifications as are suited to the particular use contemplated.

### Computer System Overview

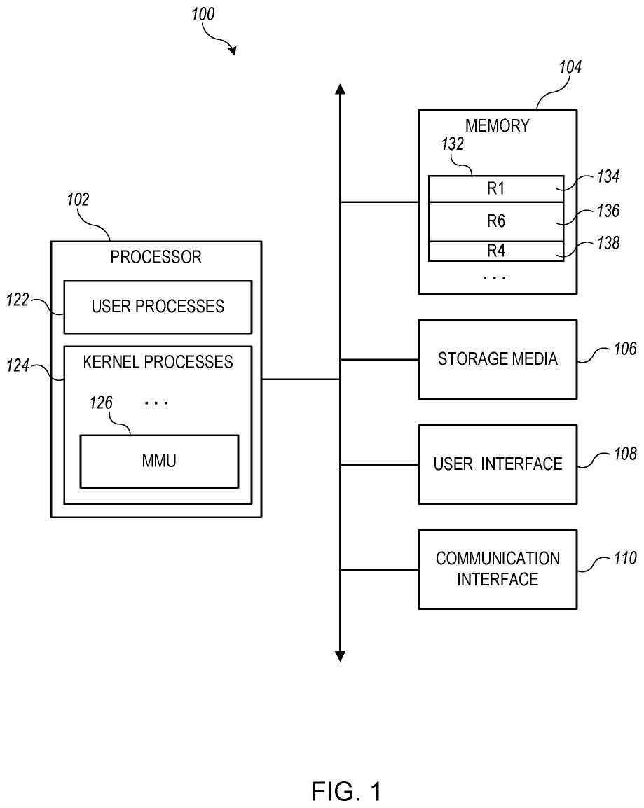

FIG. 1 shows a simplified block diagram of a computer system 100 configured to execute various processes according to some embodiments. Computer system 100 includes a processor 102, a memory 104, storage media 106, a user interface 108, and a communication interface 110. Processor 102 can include one or more microprocessors or microcontrollers programmed to execute various operations, including operations described herein. For example, processor 102 can execute user processes 122 and kernel processes 124. User processes 122 can include jobs that operate on input data to produce output data; such jobs can be instigated by human users, other computer systems, or other processes executing in computer system 100. Processor 102 can be capable of executing multiple user processes 122 concurrently. Kernel processes 124 can include processes associated with an operating system of computer system 100, including processes that manage the allocation of resources of system 100 among different concurrently executing user processes 122. Kernel processes 124 can operate concurrently with user processes 122, and portions of system resources can be allocated to kernel processes 124. For example, a memory management unit (MMU) 126 can manage allocation of portions of memory 104 to different user processes 122. Example implementations of memory management unit 126 are described below.

Memory 104 can provide a pool of working memory for processor 102, to enable fast storage and retrieval of data and/or instructions in use by processes executing on processor 102, including user processes 122 and kernel processes 124. Memory 104 can be implemented using a variety of technologies such as DRAM, SRAM, or any other technology suitable for real-time addressable access to data by processor 102. Memory 104 is associated with an address space 132 in which different storage locations are assigned unique identifiers (referred to as “addresses”), and any location can be accessed at any point during execution of a process by reference to the address assigned to that location. In examples described herein, linear addressing is used, in which contiguous physical locations are assigned consecutive numerical identifiers. Other addressing schemes can also be supported. As shown in FIG. 1, portions of the pool of memory provided by memory 104 can be allocated to specific executing processes. In this example, contiguous portions (referred to herein as “blocks” or “segments”) of address space 132 (or of the memory pool to which address space 132 refers) can be allocated to different processes: in this example, a first block 134 is allocated to a process “R1,” a second block 136 is allocated to a process “R6,” and a third block 138 is allocated to a process “R4.” According to some embodiments, memory allocations can be determined by memory management unit 126 using techniques described below.

Storage media 106 can include any combination of non-transitory storage hardware for data (including program code), such as magnetic disk, optical disk, flash memory, programmable read-only memory, or the like, and the storage hardware may include removable and/or fixed storage hardware. In some embodiments, a virtual memory system can be implemented, in which a portion of storage media 106 can be used as a backing store for memory 104 and the memory addresses can be virtual rather than fixed physical locations. A virtual address translation table can be provided to allow programs to reference memory locations using a virtual address that may map to different physical addresses at different times.

User interface 108 can include conventional hardware components such as a display, keyboard, keypad, touchscreen, speakers, microphone, and/or any other component that can be operated to receive input from and/or present output to a user. In some embodiments, user interface 108 can be minimal or nonexistent.

Communication interface 110 can include conventional hardware components such as antennas and supporting baseband hardware for wireless communication using standard protocols, such as Bluetooth, Wi-Fi, or NFC, and/or proprietary protocols as desired. In addition or instead, communication interface 110 can include hardware components for wired communication, such as a USB connector, an Ethernet connector, or one or more other connectors. Communication interface 110 can also include supporting control logic to operate the communication hardware; such control logic can be implemented using dedicated logic devices (e.g., FPGA or ASIC) and/or program code executing on a suitable processor, which can be processor 102 or a different programmable microprocessor. Depending on implementation, communication interface 110 can support point-to-point communication or communication via a local or wide area network (including the internet).

A computer system can include a plurality of the components or subsystems, e.g., connected together by external interface or by an internal interface (e.g., a system bus). In some embodiments, computer systems, subsystems, or apparatuses can communicate over a network. In such instances, one computer can be considered a client and another computer a server, where each can be part of a same computer system or different computer systems. A client and a server can each include multiple systems, subsystems, or components. Computer systems can be implemented in a variety of form factors and devices ranging from server farms to desktop or laptop computers to special purpose devices such as point-of-sale (POS) terminals to mobile devices such as smart phones, tablets, or wearable devices. In some embodiments, a computer system includes a single computer apparatus, where the subsystems can be components of the computer apparatus. In other embodiments, a computer system can include multiple computer apparatuses, each being a subsystem, with internal components.

Computer system 100 is assumed to be capable of processing multiple jobs (or programs, processes, threads, or other sequences of instructions) concurrently and can allocate portions of available resources (e.g., memory, CPU cycles, network bandwidth) to each concurrent job. In some embodiments, computer system 100 can operate as a server computer that executes jobs received from (or otherwise directed by) client computers, e.g., via communication interface 110. The jobs can include recurring jobs. For instance, computer system 100 may operate as a financial transaction processing server (e.g., a server computer that processes credit card or debit card transactions), and the jobs can include batches of transaction data from various merchants and/or banks that are periodically submitted for processing. Recurring jobs may be submitted at regular intervals, such as hourly or daily. Techniques described herein assume at least some patterns exist in the order and timing of memory requests, as is likely to be the case with recurrent scheduled submissions of jobs of the same type from different sources. While financial transaction processing is used as an example of recurring jobs, the particular type or subject matter of processing jobs is not critical to understanding the present disclosure.

### Memory Management Using Machine Learning

Physical working memory in a computer system is a finite resource. While virtual memory can be used to allow larger amounts of memory to appear to exist, virtual memory can negatively affect performance, as data must be swapped between the physical working memory (typically implemented using fast-access circuits such as DRAM circuits) and a backing store (which may have longer access times). For efficient processing and fast throughput, optimizing utilization of physical memory is desirable. According to some embodiments, memory utilization can be improved by implementing machine learning, such as reinforcement learning, to determine an order of allocation that can reduce fragmentation.

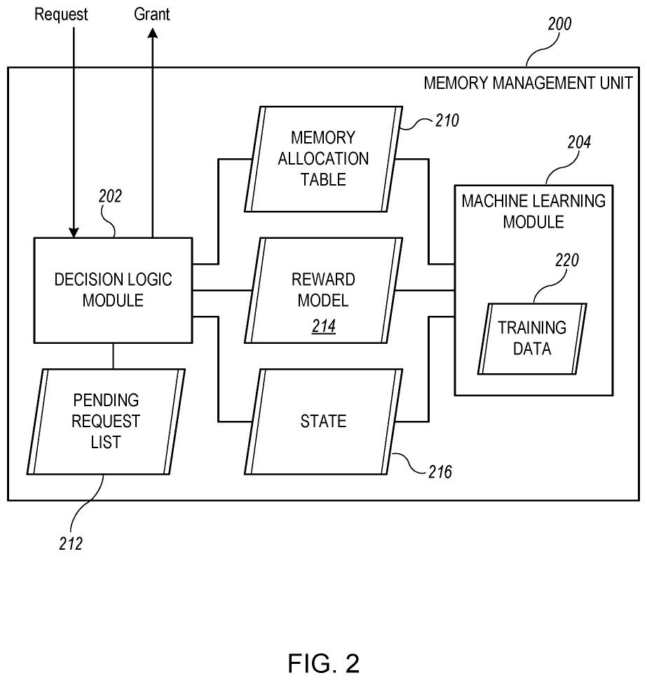

FIG. 2 shows a simplified block diagram of a memory management unit 200 according to some embodiments. Memory management unit 200 can be used, e.g., to implement memory management unit 126 in computer system 100 of FIG. 1.

Memory management unit 200 includes a decision logic module 202 and a machine learning module 204, each of which can be implemented using program code executable in a processor such as processor 102. Decision logic module 202 and machine learning module 204 can execute as kernel processes, and as such may consume some system resources.

Memory allocation table 210 can include a map identifying which portions of the address space have been allocated to which processes. Various implementations, including conventional and other data structures, can be used. Decision logic module 202 can receive requests for memory allocation for jobs being executed. Each request can include a job identifier and an amount of memory requested (e.g., in bytes or kilobytes or other convenient unit). In some embodiments, the job identifier can include a first data element indicating a job type (e.g., hourly merchant batch job) and a second data element that uniquely distinguishes the instance of the job. Additional information, such as an identifier of the source of the job (e.g., a particular client computer), can also be included. For convenience of description, it is assumed herein that each job generates exactly one memory allocation request, which can be made at the beginning of execution of the job, and that the allocated memory is released (freed for use by other processes) when execution of the job is terminated. Other memory allocation paradigms can be substituted, including allowing multiple allocation requests per job. Decision logic module 202 or other components of memory management unit 200 can also receive requests to free memory that was previously allocated to jobs that have terminated. In embodiments described herein, memory is freed on request, thereby increasing available memory for subsequent jobs.

According to some embodiments, decision logic module 202 need not grant memory allocation requests in the order received. In particular, decision logic module 202 can determine whether to grant a request (and in what order) using a reward model 214 that has been trained using machine learning module 204, as described below. The determination depends on the state of the memory, which can include a current request as well as context information such as previous requests that have been granted, pending requests, and/or expected future requests. Accordingly, memory management unit 200 can store state information 216, including context information, for use by decision logic module 202. If a request is not granted upon receipt, decision logic module 202 can add the request to a pending request list 212. As described below, decision logic module 202 can periodically make determinations whether to grant each pending request in list 212 or continue to wait.

When decision logic module 202 grants a request, decision logic module 202 allocates memory to the requesting job. In embodiments described herein, requested memory is allocated as a single contiguous block of the requested size. Decision logic module 202 can return a “grant” response that can include the starting address of the allocated block and can also include other information such as the job identifier and the size of the allocated block.

In some embodiments, machine learning module 204 can train reward model 214 using reinforcement learning techniques such as Q-learning. “Reinforcement learning” refers to a form of machine learning in which the system in a given state determines the next action to take based on maximizing a predicted cumulative reward (also referred to as an “expected reward”). “Q-learning” is an off-policy reinforcement learning technique that can learn from actions that are outside currently established policy. For instance, confronted with a new state and a finite set of possible actions, the system can randomly select an action, observe the result, and use that information to update a reward model. The updated reward model can thereafter inform selection of an action when the state is encountered again. Q-learning is based on a reward model in which taking a particular action (αₜ) αₜ timestep t while in a particular state (sₜ) is associated with an expected reward function Q (sₜ, αₜ). Using the Bellman equation, the predicted cumulative reward model Q (sₜ, αₜ) can be updated according to:

$${Q}^{new} ( {s}_{t} , {a}_{t} ) ← Q ( {s}_{t} , {a}_{t} ) + α \cdot ( r ( {s}_{t} , {a}_{t} ) + γ \cdot {max}_{a} Q ( {s}_{t + 1} , a ) - Q ( {s}_{t} , {a}_{t} ) ) ,$$

where sₜ₊₁ is a future state resulting from taking an action α while in state sₜ; α is a learning rate (selected 0<α≤1); r (sₜ, αₜ) is an incremental reward received when moving from state sₜ to state sₜ₊₁ by taking action αₜ;

$${max}_{a} Q ( {s}_{t + 1} , a )$$

represents a maximum “future” reward that can be obtained from taking an action in state sₜ₊₁; and γ is a discount factor (selected from 0≤γ<1) that provides a relative weighting between the immediate and future rewards. The learning rate a and discount factor γ are hyperparameters of the model and can be selected as desired. In some embodiments, the maximum future reward

$${max}_{a} Q ( {s}_{t + 1} , a )$$

can be replaced by a weighted sum of multiple future rewards covering multiple future timesteps.

In the context of memory management unit 200, the incremental reward r (sₜ, αₜ) can be defined based on observing the effect on subsequent memory utilization of decisions to grant an allocation request or wait for a subsequent event. For instance, a state can be defined as a context in which decision logic module 202 receives a request from a job of a particular type. The context can include information about requests that have previously been allocated (and not yet deallocated), as well as pending requests (previously received but not yet allocated) and expected future requests (which may be implicitly or explicitly identified). For purposes of the reward model, different requests can be distinguished based on parameters that are expected to recur, such as job type, source of the job, or the like. Request identifiers that are not correlated to the size of the memory allocation request or duration of the job are generally less informative to the model and can be omitted from the state information. In any given state, a “current” allocation request is being considered, and two actions are possible with respect to the current request: allocate now or do not allocate now (also referred to as “wait”). Each action has an effect on a memory utilization αₜ a subsequent time. Memory utilization can be quantified, for example, as a parameter xu, where u represents the maximum possible memory utilization (e.g., the total amount of memory available for user processes), and usage factor 0≤x≤1 represents the fraction of memory that is in use.

Machine learning module 204 can determine immediate rewards r (sₜ, αₜ) for particular states and actions using a machine learning process applied to training data 220. Training data 220 can be stored in a training data store, which can be implemented using any data storage medium, including RAM, disk, flash memory, or a combination thereof. Training data 220 can include information about past states encountered by decision logic module 202 (e.g., sequences of requests received and allocated), the action taken from a particular state (e.g., allocating or not allocating memory for a particular request), and observed memory utilization data (e.g., values of xu) αₜ various times during and/or after the sequence of requests and allocations. Machine learning module 204 can associate actions taken in a given state with a subsequent increase or decrease in memory utilization and assign rewards accordingly. In some embodiments, where an action (in a given state) is associated with increased memory utilization, that action is assigned a positive reward (r (sₜ, αₜ)>0), and where an action (in a given state) is correlated with decreased memory utilization, that action is assigned a negative reward (r (sₜ, αₜ)<0). Machine learning module 204 can use these assignments to train a predicted cumulative reward model Q (sₜ, αₜ) for various states and actions. For purposes of training of reward model 214 and operation of decision logic module 202, each request can be associated with a job type and need not be associated with a particular instance of a job.

In some embodiments, decision logic module 202 can start by randomly deciding whether to allocate or not allocate as requests are received, and machine learning module 204 can collect training data 220 by recording the decisions and observing the resulting memory utilization. After training data is collected, machine learning module 204 can solve an optimization problem to determine preferred decisions for various sets of received requests and can update reward model 214. The optimization problem can be solved, e.g., by computing expectation values of memory utilization for various allocation sequences.

Iterative learning can be implemented. For instance, after initial training and deployment of reward model 214, machine learning module 204 can continue to collect training data 220 and can re-solve the optimization problem using new or updated training data 220. Iterative learning can be performed at regular intervals or as new types of requests are introduced. New data points can be added to existing training data 220, and the training data set can grow over time. In some embodiments, old data points may be discarded after some period of time, e.g., to keep the size of the training data set from growing without limit.

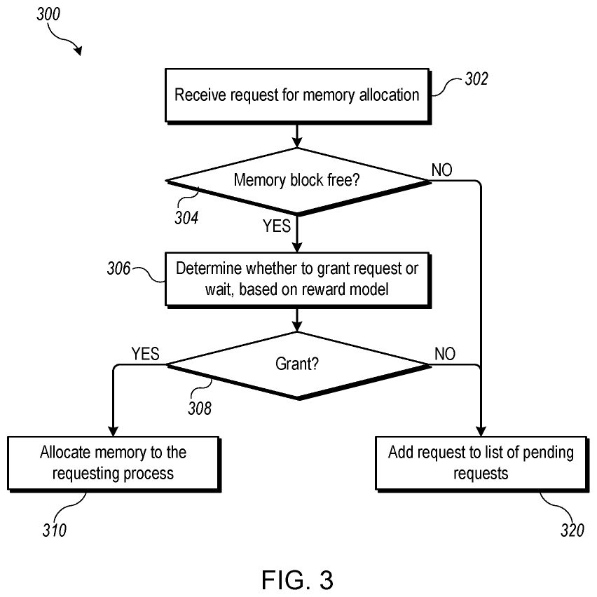

FIG. 3 is a flow diagram of a process 300 for handling a memory allocation request according to some embodiments. Process 300 can be implemented as part of a memory management process in a memory management unit of a computer system, e.g., in decision logic module 202 in memory management unit 200.

At block 302, decision logic module 202 can receive a request for memory allocation. The request can indicate the amount of memory requested (also sometimes referred to as the size of the request) and an identifier of the job to which memory is to be allocated. As noted above, the identifier can include information indicative of the type of request (e.g., job type and/or requester) that can facilitate recognition of patterns in the requests and resulting memory utilization. At block 304, decision logic module 202 can determine whether a contiguous block of memory of the requested size is currently free. If not, then at block 320, the request can be added to a list of pending requests, e.g., pending request list 212. As described below, pending request list 212 can be processed periodically, and when memory becomes free, the request may be granted.

If a contiguous block of memory of the requested size is free, then αₜ block 306, decision logic module 202 can determine whether to grant the request (i.e., allocate the block of memory) or wait. The determination can be made using reward model 214. For example, as described above, for each of a number of different states s, reward model 214 can include an expected reward Q (s, α=Y) and an expected reward Q (s, α=N) where α=Y denotes a decision to allocate and α=N denotes a decision not to allocate (i.e., to wait). As noted above, the state can include the request under consideration as well as information about other pending requests, previously granted requests, and/or expected future requests. Based on the current state sₜ, decision logic module 202 can determine Q (sₜ, αₜ=Y) and Q (sₜ, αₜ=N) (e.g., by retrieving values from reward model 214) and can determine whether to grant the request or wait, e.g., based on whether Q (sₜ, αₜ=Y) or Q (sₜ, αₜ=N) is larger. In instances where the reward model does not include an expected reward for a state matching the current state, decision logic module 202 can execute various fallback strategies. For instance, if the reward model includes expected rewards for one or more states that are similar but not identical to the current state (e.g., differ by presence/absence of a previously granted request or co-pending request), the expected rewards for the similar state(s) may be used to determine the action to take, or decision logic module 202 can make a random (or pseudorandom) determination to either grant the request or wait. Introducing randomness when an unknown state is encountered can allow observation and learning from consequences of different decisions.

If, at block 308, the decision is to grant, then αₜ block 310, decision logic module 202 can allocate the block of memory of the requested size. In cases where the allocation can be made from different portions of the address space (e.g., where there is a free contiguous block larger than the requested block), decision logic module 202 can apply various rules or policies to choose the starting address of the block. For instance, the starting address can be chosen to be the lowest free address that provides a contiguous block of the requested size. Other rules or policies can also be applied. Allocating the memory can include updating memory allocation table 210 to indicate that the block has been allocated to the requesting job and returning a grant response that can include the starting address of the block; other actions can also be taken depending on the particular implementation of the memory system.

If, at block 308, the decision is not to grant, then at block 320, the request can be added to the list of pending requests, e.g., pending request list 212. As described below, pending request list 212 can be processed periodically, and the request can be granted at a later time.

States identified and actions selected at block 306, together with subsequent observations of memory utilization, can be added to training data 220, regardless of the particular decision made or whether the decision was based on the reward model or random selection. Machine learning module 204 can periodically perform additional training cycles using training data 220 to update and refine reward model 214 in an iterative learning process. Over time, the learning process can lead to decisions that increase memory utilization relative to in-order allocation or purely random decisions.

Process 300 can allow decision logic module 202 to grant memory allocation requests out of the order of receipt, based on a trained model of the expected effect of particular grant/wait decisions on subsequent memory utilization. In some instances, this allocation technique may result in increasing memory utilization.

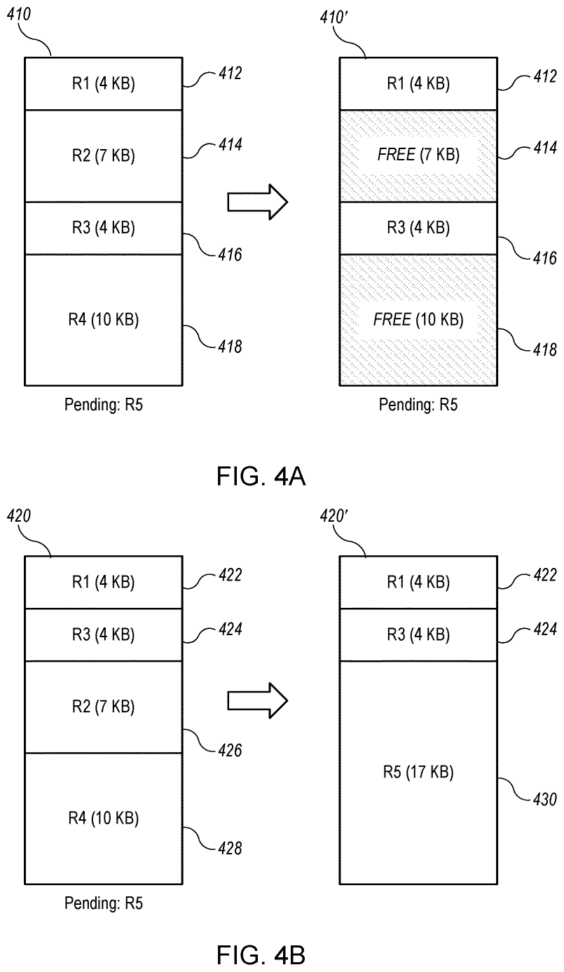

To illustrate this point, FIGS. 4A and 4B show simplified examples of memory spae allocation sequences according to some embodiments. In both instances, it is assumed that five jobs, referred to as R1-R5, make requests for memory allocations. Job R1 requests 4 KB; job R2 requests 7 KB; job R3 requests 4 KB; job R4 requests 10 KB; and job R5 requests 17 KB. It is also assumed that the requests are received in numerical sequence: R1 first, followed by R2, R3, R4, and finally R5.

Referring first to FIG. 4A, address space 410 shows a snapshot of memory utilization after granting requests for jobs R1-R4 in order. The first 4 KB (block 412) are allocated to job R1, the next 7 KB (block 414) to job R2, the next 4 KB (block 416) to job R3; and the next 10 KB (block 418) to job R4. At this time, memory for job R5 cannot be allocated as there are not 17 KB free.

In this example, it is assumed that jobs R2 and R4 finish before jobs R1 and R3. This results in memory utilization αₜ a later time as shown in address space 410′. Blocks 414 and 418, totaling 17 KB of memory, are now free. However, blocks 414 and 418 are not contiguous, and job R5 cannot receive its requested block of 17 KB. This is an example of how memory fragmentation can lead to inefficiency and impede system performance.

FIG. 4B shows an effect of a different order of granting the requests for jobs R1-R5. In this example, the request from job R2 is not granted (more specifically, memory is not allocated) until after the request from job R3 has been received and granted. Address space 420 shows a snapshot of memory utilization after granting requests in the order R1, R3, R2, R4. The first 4 KB (block 422) are allocated to job R1, the next 4 KB (block 424) to job R3, the next 7 KB (block 426) to job R2, and the next 10 KB (block 428) to job R4. At this time, memory for job R5 cannot be allocated as there are not 17 KB free.

Assuming again that jobs R2 and R4 finish before jobs R1 and R3, the resulting memory utilization αₜ a later time is shown in address space 420′. Blocks 426 and 428, totaling 17 KB of memory, have been freed, and a contiguous block 430 of 17 KB is now allocated to job R5. In this manner, job R5 can begin executing sooner, and system performance can be improved.

In the context of reinforcement learning, the examples in FIGS. 4A and 4B can both be used as training data. The allocation order of FIG. 4A results in lower, or decreased, memory utilization, and allocating R2 before R3 can be associated with a negative immediate reward r (s, α); similarly, the allocation order of FIG. 4B results in higher, or increased, memory utilization, and not allocating R2 before R3 can be associated with a positive immediate reward r (s, α). As this example suggests, expectations around future events can influence decisions about requests that have been received. In particular, in this example, the expectation that the request for job R5 will be received and additional expectations about the order in which jobs R1-R4 will finish can advantageously lead to delaying the allocation for job R2 until after the allocation for job R3 has been made. Expectations as to when particular jobs will free allocated memory or when new jobs will make requests can be but need not be expressly included in the state information; in some embodiments, such expectations can be implicitly incorporated into the reward model even if not expressly included in the state information.

It should be understood that the set of possible states is open-ended, and in some instances a request of a type not seen before may be received, or a new state may be encountered due to variations in the sequence of requests received. However, the basic principle is applicable: given a state and a pending request to allocate memory (and assuming that memory is available), a memory management unit can determine whether to make the requested allocation or wait, based on expected rewards.

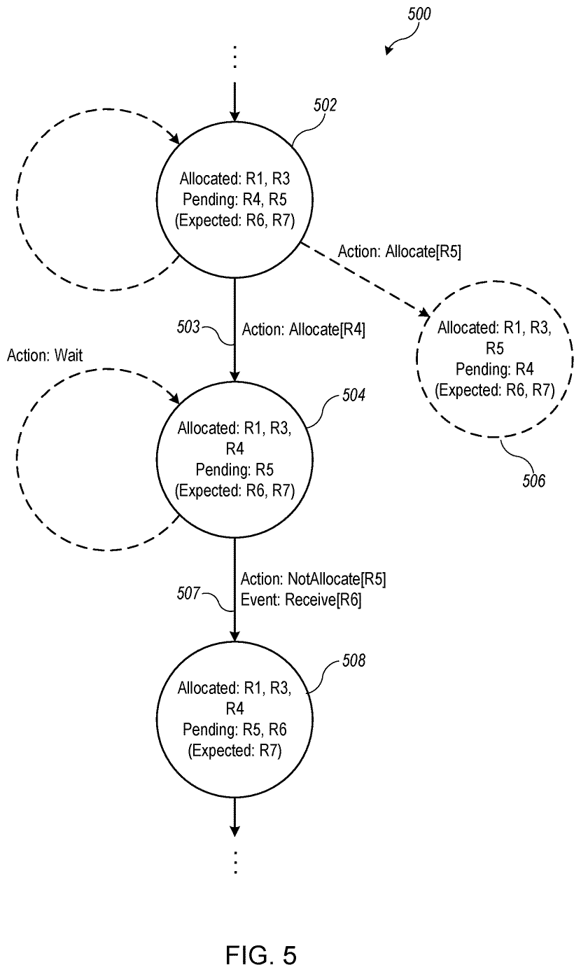

FIG. 5 illustrates a portion of a state machine 500 according to some embodiments. In this example, αₜ state 502, requests R1 and R3 have been allocated; requests R4 and R5 are pending; and requests R6 and R7 are predicted (or expected to be received within some window of time). In some embodiments, it may be useful to expressly include information about predicted subsequent requests in the definition of a state. However, as noted above, patterns of predicted subsequent requests can affect a decision in the present, regardless of whether expected subsequent requests are expressly included in the definition of a state.

From state 502, the following actions are possible: allocate memory for request R4, allocate memory for request R5, or wait (do not allocate for either request). In this example, a decision is made (e.g., based on comparing expected rewards for each possible action) to allocate memory for request R4. This action results in transition 503 to a state 504, in which requests R1, R3, and R4 are allocated; request R5 remains pending; and requests R6 and R7 are still expected. As shown by the dashed lines, a decision to allocate R5 instead would result in transition to a different state 506, and a decision not to allocate for either request would result in remaining in state 502.

While in state 504, a decision not to allocate memory for request R5 can result in remaining in state 504. If another request (R6 in this example) is received before memory is allocated for R5, a transition 507 to another state 508 occurs. In state 508, requests R1, R3, and R4 have been allocated; requests R5 and R6 are pending; and request R7 is expected. A number of different transitions might occur from state 508. For example, memory might be allocated for request R5 or for request R6 (ahead of R5), or both requests might remain pending until predicted request R7 is subsequently received or some other event occurs. As this example suggests, the state machine can include a large number of states. Estimated rewards for each state can be learned over time, e.g., using Q-learning as described above or other reinforcement learning techniques.

In the examples described above, a request that is not granted upon receipt is added to a pending request list (e.g., pending request list 212). From time to time (e.g., at regular intervals or whenever a new allocation request is received or whenever a memory block becomes free), decision logic module 202 can process the pending request list to determine whether a pending request should be granted. In various embodiments, portions or all of the list may be processed at various times.

It should also be noted that the reward model does not guarantee that an allocation request will be granted within any particular amount of time. Having jobs waiting for indefinite periods to have memory allocated may not be desirable. Accordingly, some embodiments may incorporate an age-based override of the reward model, in which a request that has been pending for at least a threshold number of cycles is granted when memory is available, without regard to the reward model.

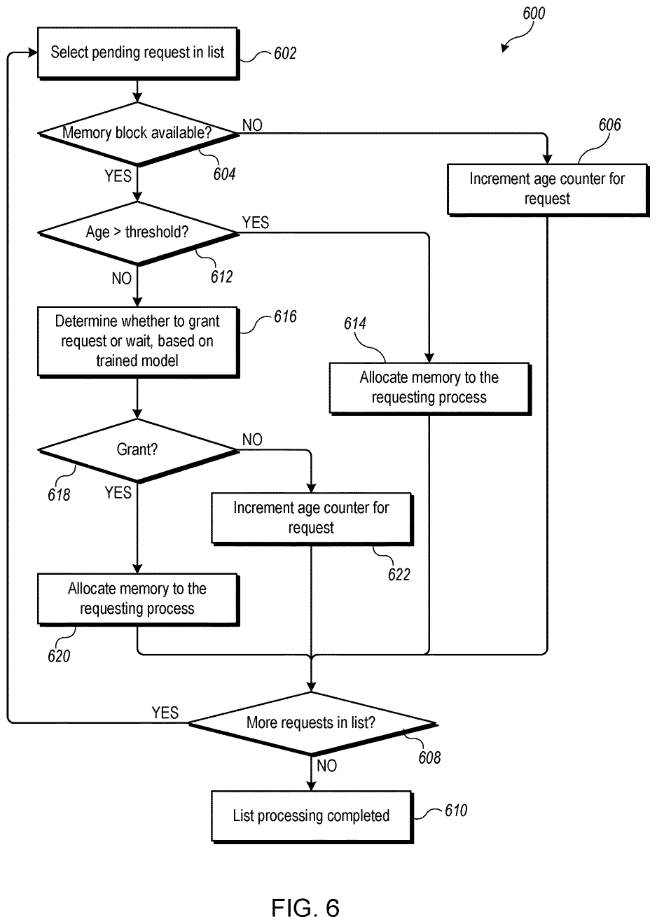

FIG. 6 shows a flow diagram of a process 600 for managing a pending request list according to some embodiments. Process 600 can be implemented as part of a memory management process, e.g., in decision logic module 202 described above using pending request list 212. In some embodiments, when a new allocation request is received, process 300 described above (or a similar process) can be used to determine whether to grant the request or add it to the pending request list. Process 600 can operate in conjunction with process 300 to manage the pending request list. In some embodiments, all memory allocation requests can be added to the pending request list upon receipt, and process 600 can manage all allocation requests. Other implementations are also possible.

In some embodiments, an age counter can be associated with each request in the list. The age counter can be initialized (e.g., to zero) when the request is added to the pending request list and incremented during process 600 as described below. Process 600 can be implemented as a loop over allocation requests in the pending request list, e.g., starting with the oldest request.

At block 602, a pending request is selected from the list, e.g., in descending order of the age counter. At block 604, decision logic module 202 can determine whether a contiguous block of memory of the requested size is currently free. If not, then at block 606, the age counter for the request can be incremented, and at decision block 608, process 600 can either return to block 602 to select the next pending request or complete processing at block 610.

If, at block 604, a contiguous block of memory of the requested size is currently free, then process 600 can determine whether to allocate the block to the selected request. At block 612, if the age counter of the request exceeds a threshold value, then at block 614, decision logic module 202 can allocate a block of memory of the requested size, similarly to block 310 of process 300 described above. The age-based allocation at block 614 is independent of the reward model and can provide a safeguard against the possibility of a job being stalled indefinitely due to lack of memory allocation. After allocating memory at block 614, at decision block 608, process 600 can either return to block 602 to select the next pending request or complete processing at block 610.

If, at block 612, the age counter of the request does not exceed the threshold value, then at block 616, decision logic module 202 can use reward model 214 to determine whether to grant the request (i.e., allocate a block of memory) or wait. Block 616 can be implemented similarly or identically to block 306 of process 300 described above.

At block 618, if the decision is to grant, then at block 620, decision logic module 202 can allocate a block of memory of the requested size, similarly to block 310 of process 300 described above. If, at block 618, the decision is not to grant, then at block 622, the age counter of the request can be incremented. (In some embodiments, the age counter can continue to be incremented beyond the threshold, e.g., if a request is stalled due to unavailability of memory.) In either case, at decision block 608, process 600 can either return to block 602 to select the next pending request or complete processing at block 610.

Process 600 is illustrative and can be modified. Process 600 incorporates the decisions of process 300, and in some embodiments, all received requests can be added to the pending request list on receipt and processed using process 600. Pending requests can be processed in any order desired; examples of policies that may be used to determine processing order include: oldest first; newest first; random order; or a prioritized order based on job type, size of memory block requested, other criteria.

As noted above, age-based allocation at block 614 can be used to limit how long a job can be delayed due to a decision to wait being made at block 616. The particular threshold age counter value that triggers age-based allocation is a system parameter that can be chosen as desired, for instance, based on observation of whether and how long jobs are actually stalled in a particular system, limits on acceptable latency in job execution, and other factors specific to a particular implementation. In some embodiments different jobs may have different threshold age counter values. For instance, jobs may be assigned different priority rankings (e.g., based on job type, source of the request, size of the memory block requested, etc.), and jobs with high priority rankings may have smaller threshold age counter values. Additional paths to avoid indefinite stalling of a job may also be implemented. For instance, if a request has been waiting due to lack of memory for a long enough time, it may be desirable to stop making new allocations in response to other requests until enough memory is free that the waiting request can be allocated.

### Additional Embodiments

While the invention has been described with reference to specific embodiments, those skilled in the art will appreciate that variations and modifications are possible. For instance, different Q-learning models or other reinforcement learning models can be used. The number of future states and actions taken into account in the reward model can be varied as desired. Further, while the foregoing description assumes that each job being executed by a computer system makes one request for a memory allocation, other schemes are possible, and in some embodiments a job may make multiple requests, e.g., at different points during execution. Accordingly, techniques of the kind described herein can be applied in any context where a memory management unit in a computer system receives memory allocation requests from multiple concurrently-executing requesters (e.g., jobs, processes, threads, etc.). To the extent that there are recurring patterns in the memory allocation requests, reinforcement learning can (implicitly or explicitly) detect the patterns, even in the presence of some variability, and can determine an order of granting requests that increases memory utilization and thereby can improve performance of the computer system. Such automated pattern detection can be useful, for instance, where the order of generating memory allocation requests is not controlled, such as where multiple independently-operating client computers send jobs to the same server computer for execution, particularly where different jobs have different execution schedules, different memory requirements, or hold memory allocations for different lengths of time.

All processes described herein are also illustrative and can be modified. Operations can be performed in a different order from that described, to the extent that logic permits; operations described above may be omitted or combined; and operations not expressly described above may be added.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable storage medium, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable storage medium may be any combination of one or more such storage devices, and suitable media may be packaged with a compatible device. Any such computer readable storage medium may reside on or within a single computer product (e.g. a hard drive, a CD, or an entire computer system), and may be present on or within different computer products within a system or network.

Such programs may also be encoded and transmitted using carrier signals adapted for transmission via wired, optical, and/or wireless networks conforming to a variety of protocols, including the Internet. As such, a computer readable transmission medium according to an embodiment of the present invention may be created using a data signal encoded with such programs. e.g., to download via the internet.

Any of the methods described herein may be totally or partially performed with a computer system including one or more processors, which can be configured to perform the steps, e.g., by providing suitable program code for execution by the processors. Thus, embodiments can involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

While various components are described herein with reference to particular blocks, it is to be understood that these blocks are defined for convenience of description and are not intended to imply a particular physical arrangement of component parts. The blocks need not correspond to physically distinct components, and the same physical components can be used to implement aspects of multiple blocks. Components described as dedicated or fixed-function circuits can be configured to perform operations by providing a suitable arrangement of circuit components (e.g., logic gates, registers, switches, etc.); automated design tools can be used to generate appropriate arrangements of circuit components implementing operations described herein. Components described as processors or microprocessors can be configured to perform operations described herein by providing suitable program code. Various blocks might or might not be reconfigurable depending on how the initial configuration is obtained. Embodiments of the present invention can be realized in a variety of apparatus including electronic devices implemented using a combination of circuitry and software.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications and description mentioned herein are incorporated by reference in their entirety for all purposes. None is admitted to be prior art.

The above description is illustrative and is not restrictive. Many variations of the invention will become apparent to those skilled in the art upon review of the disclosure. The scope of patent protection should, therefore, be determined not with reference to the above description, but instead should be determined with reference to the following claims along with their full scope or equivalents.

What is claimed is:

1. A method for managing memory in a computer system, the method comprising:
receiving, at a memory management unit of the computer system, a request from an executing process in the computer system for a memory allocation from a pool of memory, the request specifying a size of the memory allocation;
determining, by the memory management unit, based on a trained machine learning model that predicts an effect of a memory allocation decision on memory utilization, whether to grant the request or to wait;
in response to determining to grant the request, allocating, by the memory management unit, a segment of memory from the pool of memory to the executing process; and
in response to determining to wait, adding, by the memory management unit, the request to a pending request list.

2. The method of claim 1 further comprising:
periodically processing, by the memory management unit, the pending request list, wherein periodically processing the pending request list includes, for each request in the pending request list:
determining, by the memory management unit, based on the trained machine learning model, whether to grant the request or to wait;
in response to determining to grant the request, allocating, by the memory management unit, a segment of memory from the pool of memory to the executing process; and
in response to determining to wait, incrementing, by the memory management unit, an age counter for the request.

3. The method of claim 2 wherein periodically processing the pending request list further includes, for each request in the pending request list:
determining whether the age counter for the request exceeds a threshold value; and
in response to determining that the age counter for the request exceeds the threshold value, allocating a segment of memory from the pool of memory to the executing process associated with the request.

4. The method of claim 1 further comprising:
training the machine learning model using reinforcement learning wherein decisions that increase memory utilization are associated with a positive reward and decisions that decrease memory utilization are associated with a negative reward.

5. The method of claim 4 wherein training the machine learning model includes:
subsequently to determining whether to grant the request or to wait, evaluating a memory utilization outcome; and
using the memory utilization outcome to update the machine learning model.

6. The method of claim 1 wherein the machine learning model is based on optimizing an order of granting a plurality of predicted requests to reduce memory fragmentation.

7. The method of claim 1 wherein the machine learning model is trained to predict whether waiting to grant the request until after an expected subsequent request is granted will result in higher memory utilization than immediately granting the request.

8. A computer system comprising:
a processor to execute instructions, wherein the processor is configured to execute multiple jobs concurrently and further configured to execute a memory management process; and
a memory coupled to the processor and configured to store data for jobs being executed by the processor,
wherein the processor is further configured such that executing the memory management process includes:
receiving a request to allocate memory to a specific job being executed by the processor, the request specifying an amount of memory to be allocated;
determining, based on a trained machine learning model that predicts 11 an effect of a memory allocation decision on memory utilization, whether to grant the request or to wait;
in response to determining to grant the request, allocating a contiguous block of memory at least equal to the specified amount of memory to the specific job; and
in response to determining to wait, adding the request to a pending request list.

9. The computer system of claim 8 wherein the processor is further configured such that the memory management process further includes periodically processing the pending request list and such that periodically processing the pending request list includes, for each request in the pending request list:
determining, based on the trained machine learning model, whether to grant the request or to wait;
in response to determining to grant the request, allocating a segment of the memory to the specific job associated with the request; and
in response to determining to wait, incrementing an age counter for the request.

10. The computer system of claim 9 wherein the processor is further configured such that periodically processing the pending request list further includes, for each request in the pending request list:
determining whether the age counter for the request exceeds a threshold value; and
in response to determining that the age counter for the request exceeds the threshold value, allocating a segment of the memory to the specific job associated with the request.

11. The computer system of claim 8 further comprising:
a communication interface configured to communicate with one or more other computer systems,
wherein the processor is further configured to receive requests to execute jobs via the communication interface.

12. The computer system of claim 8 wherein the processor is further configured to execute a machine learning process to train the machine learning model.

13. The computer system of claim 12 wherein the machine learning process uses reinforcement learning in which decisions that increase memory utilization are associated with a positive reward and decisions that decrease memory utilization are associated with a negative reward.

14. The computer system of claim 12 further comprising:
a training data store configured to store training data for the machine learning process, the training data including sequences of received requests, sequences of allocations made in response to received requests, and memory utilization data,
wherein the processor is further configured to add training data to the training data store while executing the memory management process.

15. A computer-readable storage medium having stored therein program code instructions that, when executed by a processor of a computer system, cause the computer system to implement a memory management process comprising:
receiving a request from an executing job in the computer system for a memory allocation from a pool of memory, the request specifying a size of the memory allocation;
adding the request to a pending request list; and
periodically processing the pending request list, wherein processing the pending request list includes, for each pending request:
determining, based on a trained machine learning model that predicts an effect of a memory allocation decision on memory utilization, whether to grant the pending request or to wait;
in response to determining to grant the pending request, allocating a segment of memory from the pool of memory to the executing job; and
in response to determining to wait, incrementing an age counter associated with the pending request.

16. The computer-readable storage medium of claim 15 wherein processing the pending request list further includes, for each pending request:
determining whether the age counter for the request exceeds a threshold value; and
in response to determining that the age counter for the request exceeds the threshold value, allocating a segment of memory from the pool of memory to the executing job associated with the request.

17. The computer-readable storage medium of claim 15 having stored therein additional program code instructions that, when executed by a processor of a computer system, cause the computer system to implement a machine learning process to train the machine learning model.

18. The computer-readable storage medium of claim 17 wherein the machine learning process implements reinforcement learning wherein decisions that increase memory utilization are associated with a positive reward and decisions that decrease memory utilization are associated with a negative reward.

19. The computer-readable storage medium of claim 15 wherein the machine learning model is based on optimizing an order of granting a plurality of predicted requests to reduce memory fragmentation.

20. The computer-readable storage medium of claim 15 wherein the machine learning model is trained to predict whether waiting to grant the request until after an expected subsequent request is granted will result in higher memory utilization than immediately granting the request.
